(19) United States
(12) Patent Application Publication
(10) Pub. No.: US 2024/0097535 A1
(43) Pub. Date: Mar. 21, 2024

(54) ELECTRIC COMPRESSOR

(71) Applicant: Hanon Systems, Daejeon (KR)

(72) Inventors: Hyun Woo Lee, Daejeon (KR); Min Gyu Kim, Daejeon (KR); Sang Woo Bae, Daejeon (KR); Hye Rim An, Daejeon (KR); Sung Taeg Oh, Daejeon (KR); Je Su Yun, Daejeon (KR)

(21) Appl. No.: 18/261,179

(22) PCT Filed: Sep. 6, 2022
(86) PCT No.: PCT/KR2022/013334

§ 371 Date: Nov. 27, 2023

(30) Foreign Application Priority Data
Sep. 9, 2021 (KR) 10-2021-0120612

(51) Int. Cl. H02K 11/33; F25B 31/02; H02K 7/14

(52) U.S. Cl. CPC H02K 11/33; F25B 31/026; H02K 7/14; H02K 2211/03

(57) ABSTRACT

An electric compressor capable of reducing a size and lightening weight of a package of an inverter unit, as a common mode choke (CM choke) is disposed radially outside of a circuit board of the inverter unit, and a high voltage connector, a CM choke, and a low voltage connector are integrated into a support body.

### CROSS REFERENCE TO RELATED PATENT APPLICATIONS

This is a U.S. national phase patent application of PCT/KR2022/013334 filed Sep. 6, 2022 which claims the benefit of and priority to Korea Patent Application No. 10-2021-0120612 filed on Sep. 9, 2021, the entire contents of each of which are incorporated herein by reference.

### FIELD

The present disclosure relates to an electric compressor, and more particularly, an electric compressor capable of reducing a size and lightening weight of a package of an inverter unit, as a common mode choke (CM choke) is disposed radially outside of a circuit board of the inverter unit, and a high voltage connector, a CM choke, and a low voltage connector are integrated into a support body.

### BACKGROUND

Generally, air conditioning (A/C) apparatuses for cooling or heating passenger compartments are installed in vehicles. Such an air conditioning apparatus includes a compressor, which compresses low-temperature and low-pressure gaseous refrigerant drawn from an evaporator into a high-temperature and high-pressure gaseous state, and transfers it to a condenser.

Compressors applied to such vehicles include a mechanical compressor that is driven by receiving the driving force of the engine and an electric compressor that uses a motor driven by electricity, and in recent years, the use of electric compressors has increased as the vehicle electrification has been accelerated.

Meanwhile, examples of the compressor include a reciprocating compressor that compresses a refrigerant according to which pistons reciprocate, and a rotary compressor that compresses a refrigerant while rotating. The reciprocating compressor includes a crank compressor that transmits a driving force from a drive source to a plurality of pistons using a crank, a swash plate compressor that transmits a driving force from a drive source to a shaft installed with a swash plate, and the like, according to the power transmission from the drive source. The rotary compressor includes a vane rotary compressor that utilizes a rotating rotary shaft and vane, and a scroll compressor that utilizes an orbiting scroll and a fixed scroll.

In addition, in the field of the electric compressor, the development of an inverter-type compressor capable of varying the operating speed of the motor is being actively conducted. In the inverter-type electric compressor, the inverter is mounted on an outer circumferential surface or one side of a casing, and the inverter is electrically connected to a motor provided inside the casing using terminals and bus bars passing through the casing.

Here, in the conventional electric compressor, a CM choke for reducing high-frequency noise is disposed in a circuit board of the inverter. For example, referring to a motor compressor disclosed in Korean patent application publication No. 2020/0115215, a common mode choke coil 34 is mounted on a circuit board 29 of the inverter, and by doing so, transmission of the high frequency noise generated from the PCU 39 on the vehicle side to the inverter circuit 31 on the compressor side is suppressed.

In this way, as the CM choke is disposed inside the inverter cover member 25 on the circuit board 29, an area of the circuit board 29 increases, so that a width and height of the inverter cover member 25 must also increase. Therefore, there is a problem in that it is difficult to reduce the package and make it lightweight.

Moreover, since the connector 27 is provided on an outside of the inverter cover member 25 and protrudes in an opposite direction of the motor, the overall length of the electric compressor is also increased.

### SUMMARY

An object of the present disclosure is to provide an electric compressor capable of reducing and lightening the package of the inverter unit by disposing a CM choke (common mode choke) radially outside the circuit board of the inverter unit and integrating a high voltage connector, a CM choke and a low voltage connector into a support body.

The technical problem to be achieved by the present disclosure is not limited to the above-mentioned technical problem, and other technical problems that are not mentioned will be clearly understood by ordinary-skilled persons in the art to which the present disclosure pertains from the following description.

One embodiment is an electric compressor, including: a housing; a compression unit provided in the housing; a motor unit provided in the housing to drive the compression unit; and an inverter unit fastened to one side of the housing and controlling the motor unit, and the inverter unit may include: a support body disposed on one side of the housing; a circuit board seated on the support body; an inverter cover coupled to the housing to cover a portion of the support body on which the circuit board being seated; and a CM choke installed in the support body in a way to be disposed radially outside the circuit board.

According to an embodiment, the inverter cover may not cover the CM choke.

According to an embodiment, the support body may include: a center part allowing the circuit board to be seated thereon; and a first receiving part extending from a radially outer side of the center part toward the housing or toward an opposite side of the housing, and having the CM choke disposed therein.

According to an embodiment, the support body may further include a second receiving part extending from a radially outer side of the center part toward an opposite side of the first receiving part, and having a high voltage connector disposed therein.

According to an embodiment, the first receiving part and the second receiving part may be disposed at the same location in a circumferential direction of the center part.

According to an embodiment, a high voltage line of the high voltage connector may be directly connected to the CM choke through an inside of the support body.

According to an embodiment, the CM choke may be connected to the circuit board through a bus bar disposed inside the support body.

According to an embodiment, the support body may further include: a third receiving part extending from a radially outer side of the center part toward the same side as the second receiving part and having a low voltage connector disposed therein.

According to an embodiment, a low voltage line of the low voltage connector may be connected to the circuit board through a bus bar disposed inside the support body.

According to an embodiment, the second receiving part and the third receiving part may be disposed at an angle of 30° or more and 180° or less in the circumferential direction of the center part.

According to an embodiment, the center part of the support body and the inverter cover may be formed in a circular shape, and the inverter cover may cover the center part.

According to an embodiment, the support body may be provided with fastening holes for fastening the circuit board and the support body.

According to an embodiment, groove portions for fastening the inverter cover and the housing may be provided on an outside of the support body.

According to the present disclosure, the size of the circuit board can be reduced as the CM choke is disposed outside the circuit board in a radial direction, and since the CM choke is not disposed inside the inverter cover, the width and length of the inverter cover can also be reduced. Accordingly, there are advantageous effects of package reduction and weight reduction of the inverter unit, cost reduction, and an increased degree of design freedom, and the overall length of the electric compressor can also be reduced.

In addition, since the high-voltage connector and the low-voltage connector are integrally configured in the support body, separate bolts and processing are unnecessary, thereby reducing the number of parts and weight, reducing costs and increasing productivity.

The effects of the embodiments of the present disclosure are not limited to the above-mentioned effects, and it should be understood that the effects of the present disclosure include all effects that could be inferred from the configuration of the invention described in the detailed description of the invention or the appended claims.

### BRIEF DESCRIPTION OF DRAWINGS

FIG. 1 is a perspective view illustrating an electric compressor according to an embodiment of the present disclosure.

FIG. 2 is a perspective view separately illustrating a part of the motor compressor in FIG. 1.

FIG. 3 is a perspective view of FIG. 2.

FIG. 4 is a schematic front view separately illustrating the support body in which the circuit board is mounted of FIG. 2.

FIG. 5 is a side view of FIG. 4.

### DESCRIPTION OF AN EMBODIMENT

Hereinafter, exemplary embodiments of the electric compressor of the present disclosure will be described with reference to the accompanying drawings.

In addition, terms used herein are defined in consideration of functions in the present disclosure, and may vary according to user's or operator's intention or practices, and the following embodiments do not limit the scope of the present disclosure, but are merely examples of the components presented in the claims.

In addition, parts irrelevant to the description are omitted for clarity of description, and same or similar components are assigned with the same reference numerals throughout the specification. It will also be understood that the terms “comprises” and “includes” used herein specify the presence of stated elements, but do not preclude the presence or addition of other elements, unless otherwise defined.

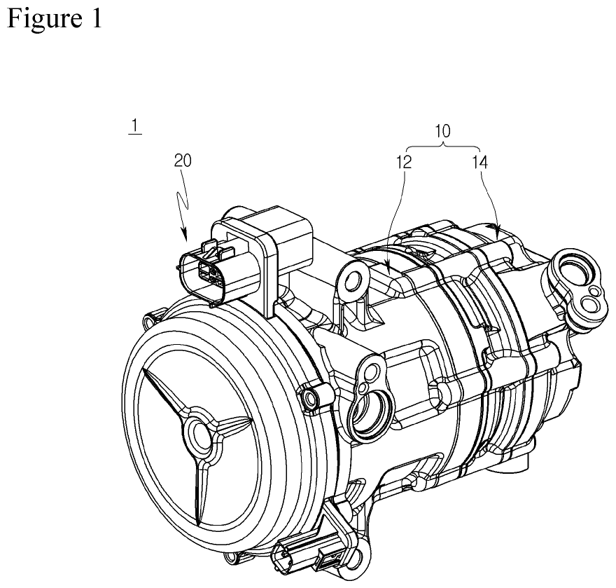

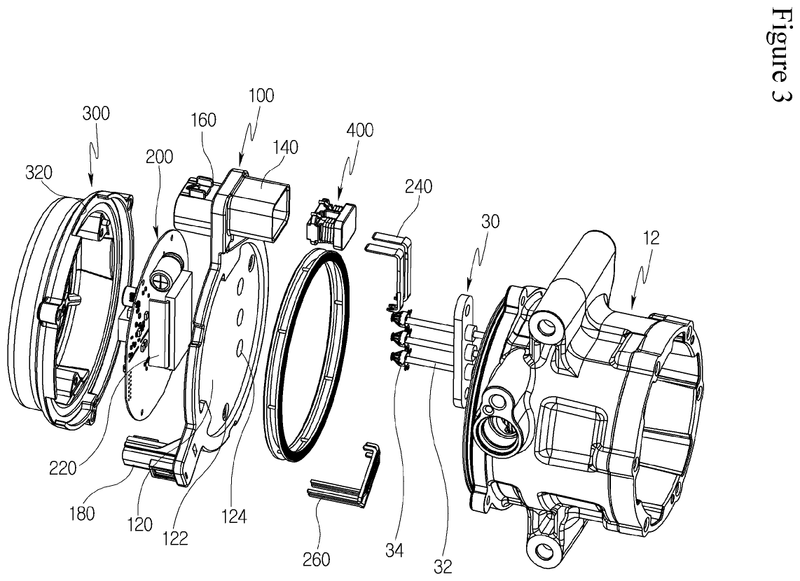

First, the configuration of the electric compressor 1 according to an embodiment of the present disclosure will be briefly described with reference to FIGS. 1 to 3.

The electric compressor of the present disclosure largely includes a housing 10, a motor unit, a compression unit, an inverter unit 20, and a terminal unit 30 electrically connecting the motor unit and the inverter unit 20.

The housing 10 forms an exterior of the electric compressor 1, and in this embodiment, the housing 10 consists of a front housing 12 and a rear housing 14.

The motor unit is provided in the front housing 12, and provides power for compressing a refrigerant to the compression unit. Although not illustrated, the motor unit may include a rotor coupled to a rotary shaft rotatably installed at a center part of the front housing 12 and a stator fixed to the front housing 12 and disposed radially outside the rotor. Also, the stator may include a stator core and coils wound around the stator core.

The compression unit is provided in the rear housing 14 and although not illustrated, may include an orbiting scroll coupled to the rotary shaft through an eccentric bush, and a fixed scroll fixed between the front housing 12 and the rear housing 14 to form a compression chamber in which the refrigerant is compressed together with the orbiting scroll. As such, since the compression unit is connected to the motor unit through the rotary shaft, the rotational force generated by the motor unit may be transmitted to the orbiting scroll of the compression unit through the rotary shaft. However, it is not limited thereto, and it is apparent that other types of compression units may be used.

The inverter unit 20 is coupled to one side of the housing 10 which is an opposite side of the compression unit with respect to the motor unit. The inverter unit 20 is electrically connected to the motor unit, supplies power to the motor unit and controls operations by means of power and control signals transmitted from an outside. Specifically, the stator forms an electromagnetic field by power applied from the inverter unit 20, and rotational force for driving the compression unit is generated as the rotor rotates by the electromagnetic field formed by the stator.

At this time, the motor unit and the inverter unit 20 may be electrically connected to each other by the terminal unit 30. Although not limited thereto, since a three-phase motor is used in this embodiment, three terminals 34 and three connection pins 32 connected to the three phases respectively in order to supply three-phase power from the inverter unit 20 to the motor unit are provided. The three connection pins 32 are connected to the three-phase coils of the stator, pass through the housing 10 and protrude toward an inside of the inverter unit 20. Each of the connection pins 32 protruding to the inside of the inverter unit 20 penetrates a circuit board 200 of the inverter unit and is electrically connected to the circuit board 200 through respective terminals 34.

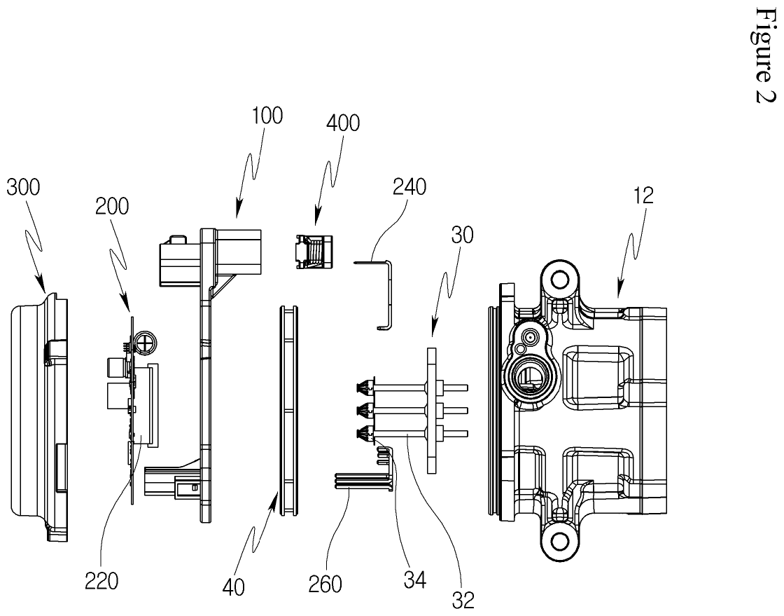

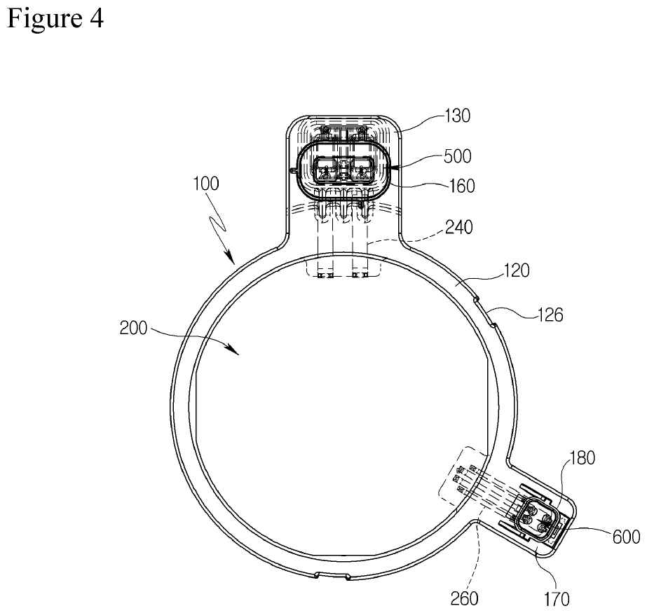

Hereinafter, the inverter unit 20 will be described in detail with reference to FIGS. 2 to 5. The inverter unit 20 may largely include a support body 100, the circuit board 200, an inverter cover 300, a CM choke 400, a high voltage connector 500 and a low voltage connector 600.

The support body 100 is disposed on one side of the front housing 12, and the circuit board 200 having the switching elements 220 is seated on the support body 100. In this embodiment, the support body 100 includes a circular center part 120 on which the circuit board 200 is seated. The support body 100 may be made of resin.

Here, fastening holes 122 for fastening the circuit board 200 and the support body 100 are provided in the support body 100, more precisely, in the center part 120 of the support body. As a result, fastening parts such as a bolt pass through the circuit board 200 and the fastening holes 122 of the support body 100 and are fastened to the front housing 12, so that the circuit board 200 can be fixed on the center part 120 of the support body. In addition, through holes 124 through which the connection pins 32 of the terminal unit 30 passes are provided in the center part 120 of the support body. In addition, slots for seating the switching elements 220 may be formed in the center part 120 of the support body.

In the present disclosure, the CM choke 400 is installed in the support body 100 in a way to be disposed radially outside the circuit board 200. To this end, the support body 100 includes a first receiving part 140 extending from the radially outer side of the center part 120 toward the housing 10 and in which the CM choke 400 is disposed. Specifically, the first protrusion 130 protrudes outward in a radial direction from the center part 120 of the support body, and the first receiving part 140 extends toward the housing 10 from the first protrusion 130. However, it is not limited thereto, and the first receiving part 140 may extend toward an opposite side of the housing 10.

In addition, the support body 100 may further include a second receiving part 160 extending from the radially outer side of the center part 120 to an opposite side of the first receiving part 140 and in which the high voltage connector 500 is disposed. Here, it is preferable that the first receiving part 140 and the second receiving part 160 are disposed at the same location in a circumferential direction of the center part 120. The second receiving part 160 may be disposed behind the first receiving part 140. Specifically, the second receiving part 160 extends from the first protrusion 130 toward the opposite side of the housing 10.

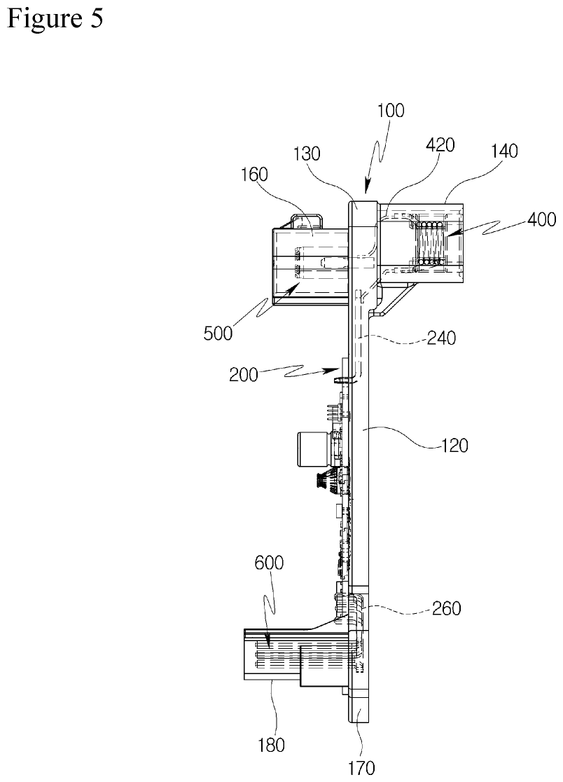

Accordingly, a high voltage line of the high voltage connector 500 may be directly connected to the CM choke 400 through an inside of the support body 100. As shown in FIG. 5, the high voltage line of the high voltage connector 500 may extend into the first protrusion 130 of the support body 100 and be directly connected to one end of a coil 420 of the CM choke 400.

In addition, the CM choke 400 may be connected to the circuit board 200 through a first bus bar 240 disposed inside the support body 100. As shown in FIG. 5, the other end of the coil 420 of the CM choke 400 is connected to the first bus bar 240, and the first bus bar 240 extends to the circuit board 200 inside the support body 100 to be electrically connected to the circuit board 200. At this time, the first bus bar 240 extends straight from the first protrusion 130 of the support body to the center part 120, and then the end thereof is bent at an angle of about 90° to penetrate the center part 120 of the support body and the circuit board 200.

In addition, the support body 100 further includes a third receiving part 180 extending from the radially outer side of the center part 120 toward the same side as the second receiving part 160 and in which the low voltage connector 600 is disposed. Specifically, a second protrusion 170 protrudes radially outward from the center part 120 of the support body, and the third receiving part 180 extends toward the opposite side of the housing 10 from the second protrusion 170. At this time, the second receiving part 160 and the third receiving part 180 may be disposed at an angle of 30° or more and 180° or less in the circumferential direction of the center part 120.

A low voltage line of the low voltage connector 600 may be connected to the circuit board 200 through a second bus bar 260 disposed inside the support body 100. As shown in FIG. 5, the low voltage line of the low voltage connector 600 is connected to the second bus bar 260, and the second bus bar 260 extends to the circuit board 200 inside the support body 100 and thus, is electrically connected to the circuit board 200. At this time, the second bus bar 260 extends straight from the second protrusion 170 of the support body to the center part 120, and then the end thereof is bent at an angle of about 90° to penetrate the center part 120 of the support body and the circuit board 200.

The inverter cover 300 is fastened to the front housing 12 to cover a portion of the support body 100 on which the circuit board 200 is seated, but does not cover the CM choke 400.

In this embodiment, the inverter cover 300 is formed in a circular shape similar to the center part 120 of the support body, and the inverter cover 300 is fastened to the front housing 12 to surround the center part 120. That is, only the circuit board 200 is disposed inside the inverter cover 300, and the CM choke 400, the high voltage connector 500, and the low voltage connector 600 are not disposed inside the inverter cover 300. To this end, two slots 320 through which the first protrusion 130 and the second protrusion 170 pass may be formed in the inverter cover 300.

In addition, a groove portion 126 for fastening the inverter cover 300 and the housing 10 may be provided on an outside of the support body 100, more precisely, on an outer side of the center part 120 of the support body. That is, the fastening part may pass through the groove portion 126 of the support body from the inverter cover 300 and be fastened to the front housing 12. As a result, the inverter cover 300 may be fastened to the front housing 12 with the support body 100 interposed between the front housing 12 and the inverter cover 300, thereby the support body 100 can be fixed. At this time, an O-ring 40 may be disposed between the support body 100 and the front housing 12 for sealing.

According to the present disclosure, as the CM choke 400 is disposed radially outside the circuit board 200, a size of the circuit board 200 can be reduced, and as the CM choke 400 is not disposed inside the inverter cover 300, a width and a length of the inverter cover 300 can also be reduced. Accordingly, there are advantageous effects of package reduction and weight reduction of the inverter unit, cost reduction, and an increased degree of design freedom, and the overall length of the electric compressor can also be reduced.

In addition, since the high voltage connector 500, the low voltage connector 600 and the CM choke 400 are configured to be integrated into the support body 100, separate bolts and processing are not required, and accordingly, the number of parts and weight can be reduced, cost can be saved and productivity can be increased.

The present disclosure is not limited to the above-described specific embodiments and descriptions, and various modifications may be made by those skilled in the art without departing from the gist of the present disclosure claimed in the claims. Such variations are within the protection scope of the present disclosure.

The present disclosure relates to an electric compressor, and more particularly, an electric compressor capable of reducing a size and lightening weight of a package of an inverter unit, as a common mode choke (CM choke) is disposed radially outside of a circuit board of the inverter unit, and a high voltage connector, a CM choke, and a low voltage connector are integrated into a support body.

1-13. (canceled)

14. An electric compressor, comprising:
a housing;
a compression unit provided in the housing;
a motor unit provided in the housing to drive the compression unit; and
an inverter unit coupled to one side of the housing and controlling the motor unit,
wherein the inverter unit further comprises:
a support body disposed on one side of the housing;
a circuit board seated on the support body;
an inverter cover fastened to the housing to cover a portion of the support body on which the circuit board is seated; and
a CM choke installed in the support body in a way to be disposed radially outside the circuit board.

15. The electric compressor of claim 14, wherein the inverter cover does not cover the CM choke.

16. The electric compressor of claim 15, wherein the support body further comprises:
a center part allowing the circuit board to be seated thereon; and
a first receiving part extending from a radially outer side of the center part toward the housing or toward an opposite side of the housing, and having the CM choke disposed therein.

17. The electric compressor of claim 16, wherein the support body further comprises a second receiving part extending from the radially outer side of the center part toward an opposite side of the first receiving part, and having a high voltage connector disposed therein.

18. The electric compressor of claim 17, wherein the first receiving part and the second receiving part are disposed at a same location in a circumferential direction of the center part.

19. The electric compressor of claim 17, wherein a high voltage line of the high voltage connector is directly connected to the CM choke through an inside of the support body.

20. The electric compressor of claim 19, wherein the CM choke is connected to the circuit board through a bus bar disposed inside the support body.

21. The electric compressor of claim 17, wherein the support body further comprises a third receiving part extending from the radially outer side of the center part toward a same side as the second receiving part and having a low voltage connector disposed therein.

22. The electric compressor of claim 21, wherein a low voltage line of the low voltage connector is connected to the circuit board through a bus bar disposed inside the support body.

23. The electric compressor of claim 21, wherein the second receiving part and the third receiving part are disposed at an angle of 30° or more and 180° or less in a circumferential direction of the center part.

24. The electric compressor of claim 16, wherein the center part of the support body and the inverter cover are formed in a circular shape, and the inverter cover covers the center part.

25. The electric compressor of claim 14, wherein the support body is provided with fastening holes for fastening the circuit board and the support body.

26. The electric compressor of claim 14, wherein groove portions for fastening the inverter cover and the housing are provided on an outside of the support body.
